(19) United States
(12) Patent Application Publication
(10) Pub. No.: US 2011/0072257 A1
(43) Pub. Date: Mar. 24, 2011

(54) METHOD AND DEVICE FOR IMPROVING ACCESSABILITY TO INFORMATION DISPLAYED ON A COMPUTER

(75) Inventor: Doron MILCHTAICH, Rehovot (IL)

(73) Assignee: INTUTULA LTD., Rehovot (IL)

(21) Appl. No.: 12/887,882

(22) Filed: Sep. 22, 2010

Related U.S. Application Data
(60) Provisional application No. 61/244,467, filed on Sep. 22, 2009.

(51) Int. Cl. G06F 9/00; G06F 17/30

(52) U.S. Cl. 713/100; 707/706; 707/E17.014; 707/E17.108

(57) ABSTRACT

A method is described for providing a user of a Personal Computer having one or more physical and/or cognitional limitations, with an improved PC experience, wherein said method comprises: a. evaluating one or more physical or cognitional limitations of the user; b. assigning values to a plurality of pre-defined parameters based on the user own evaluation, wherein at least one of the plurality of pre-defined parameters is a member of a group consisting of: brightness value, contrast value, background color, text size value, text color preference, time duration between two consecutive mouse clicks (double click), cursor size value, icons size value, Keyboard sensitivity value and mouse sensitivity value; and c. adjusting at least one of the settings' values associated with the PC used by the user, based on the value of the one or more pre-defined parameters selected out of the plurality of pre-defined parameters, to enable providing a tailored PC experience to the user.

### FIELD OF INVENTION

The present invention relates to a method and a computer program product for improving accessibility to information displayed on computers, and in particular, to the adaptation of computer experience and browsing functionality for use by elderly people and/or people having physical and/or psychological limitations.

### BACKGROUND OF THE INVENTION

Latest research reveals that the average life expectancy in western countries has been steadily growing in the last years and is expected to continue growing along with the improvements made to medical services and health care. In addition, the internet is dramatically evolving and is expected to continue evolving at a very high rate. Nowadays more and more services are accessible on-line, more and more of medical knowledge is available on-line and more and more ways are offered for connecting with loved ones over the internet. It is quite distressing that the people with physical or psychological limitations that should be the natural candidates for the possibilities that are offered by the use of the web are those who are less exposed to it, and elderly people who had retired and have the most free time on their hands are avoiding the internet due to their difficulties to access it.

Though elder and disabled people are often open and keen to use the internet, objective usability limitations prevent them from enjoying the vast pool of information and the new communication paths of the Internet. Studies that had analyzed the reasons for the declining use of the internet along with age, point out that elderly people experience characteristic usage difficulties, including:
Cognitive limitations—for example: lack of computer knowledge, unfamiliarity with common techniques (such as windows, files and folders, or common controls), fear of unfamiliar and occasionally problematic situation stimulated by their incompetence of handling these situations and graphical information clutter causing distraction and loss of focus; and
Physiological limitations—for example: sight limitations, hearing limitations, lack of eye-hand coordination and hand and fingers dexterity expressed for example in mouse usage.

The access to the internet is mostly done today using standard web browsers like Internet Explorer, Firefox and Chrome. E-mail programs like Outlook, or on-line web applications like Gmail, Hotmail and Yahoo are oriented towards the general public and assume basic computer know-how and some technical skills (even in executing simple actions like attaching photos from hard drive). Those two assumptions usually do not apply to older users. Although some operating system tweaking such as some mouse and display properties can somewhat reduce the difficulties caused by physiological limitations, their impact on usability is very limited and in any case, applying these options requires some a priori computer skills which the target population does not possesses.

There are some solutions known in the art that address this problem. The solution described by JP 2004046760 for example, tries to make it possible for the elderly people to participate in internet information network without learning the operation of a personal computer. According to JP 2004046760 solution, the bidirectional information transfer system creates and operates an internet Web page, which is dedicated to the family and has a security mechanism. As a substitute for the related family, the local organizer or the agent visit the elderly family to collect raw information, constantly report it, and update it, allow the related family to transfer the information on a bulletin board in the dedicated Web page, and provides various services to the elderly household in the local community of the elderly household as the substitute for the related family living separated therefrom.

US 20090313582 discloses a computer interface whose primary target is to achieve simplicity by providing a carefully selected subset of features most desirable by a new computer user. The invention describes a method, system and computer program designed for senior citizens, people with communications or physical disabilities (such as stroke, arthritis, cerebral palsy), people with low literacy levels or who speak English (or other language, as the case may be) as a second language (ESL), people who have learning disabilities or cognitive impairments (such as MCI or dementia), and people with little or no experience in using computerized devices as communications tools. The solution provided by this publication attempts to remove extraneous functions of a particular software program to provide only basic functions, to remove the ability to multitask thereby enabling a user to interact with the particular software program in a linear manner, and to provide only basic navigation functions.

In addition there are few software available on the market, such as Pointerware (http://www.pointerware.co.uk/c/pages/home) that tries to make computers simple and easy to use for seniors users. The problem with all the above solutions provided in the art, is, that each of them provides only one solution for a large and varied target group.

The solution provided by the present invention therefore aims to answer the specific need of senior citizens or persons with disabilities for both intuitive search engine and a customized computer experience.

### SUMMARY OF THE INVENTION

It is an object of the present invention to provide a method and a computer program product that improves computer usage and Internet accessibility for people with certain limitations.

It is another object of the present invention to provide a method and a computer program product that provides the best fitting display mode for a PC user having certain limitations.

It is still another object of the present invention to provide a method and a computer program product adapted to reduce physical and/or cognitive barriers of a PC user, and to enable him/her to easily use his/her PC and access the internet.

It is yet another object of the present invention to provide a method and a computer program product that provides an advance customized search for the PC user.

Other objects of the invention will become apparent as the description of the invention proceeds.

According to the first embodiment of the present invention there is provided a method for providing a user of a Personal Computer (PC) having one or more physical and/or cognitional limitations, with an improved PC experience. The method comprising:
a. evaluating one or more physical or cognitional limitations of the user;
b. assigning values to a plurality of pre-defined parameters associated with the user (e.g. based on the user's own evaluation of pre-defined display(s) presented to him), wherein at least one of the a plurality of pre-defined parameters is a member of a group consisting of: brightness value, contrast value, background color, text size value, text color preference, time duration between two consecutive mouse clicks (double click), cursor size value, icons size value, Keyboard sensitivity value, mouse sensitivity value, and the like; and
c. adjusting at least one of the settings' values of the PC used by the user, based on the value of the one or more pre-defined parameters selected out of the plurality of pre-defined parameters, to provide a tailored PC experience for the user.

Preferably, at least one of the settings' values of a PC to be adjusted is a member of a group consisting of: screen brightness, screen contrast, screen background color, text size, text color, time period between double clicks on the mouse, cursor size, icons' size, Keyboard sensitivity, mouse sensitivity, and the like.

The term Personal Computer (PC) as mentioned herein and throughout the specification should be understood to encompass any computerized device that enables software installation and internet browsing e.g. laptop, Ipad, smart phone, and the like.

The term “PC experience” as used herein throughout the specification and claims, is used to denote improved user-PC interface to require less efforts from the user to operate this interface. Such an improvement may be achieved by adjusting the display to accommodate the user's limitation(s), and/or to adjust the way in which any of the peripheral equipment (e.g. mouse, keyboard) is used. Consequently, the user may feel that it is easier for him/her to interact with the PC without enduring any unnecessary frustrations.

According to another embodiment of the present invention, the step of adjusting at least one of the settings' values of the PC used by the user is further based upon a specific limiting physiological and/or cognitional condition to enable adjusting display parameters of the PC to comply with the limitation. For example, adapting the screen contrast to improve the visibility for a certain user having sight impairment.

According to another embodiment of the present invention, the method provided is being implemented for use by a plurality of users using the same PC, each of which having one or more physical and/or cognitional limitations (e.g. in a home for the aged), the method further comprising the steps of:
d. associating the values of one or more pre-defined parameters, out of the plurality of pre-defined parameters, with a specific user from among that plurality of users and saving the associated values; and
e. upon identifying the specific user, adjusting at least one of the PC settings values, based on the saved values of the one or more pre-defined parameters that are associated with the identified specific user, to enable providing that user with a tailored PC experience.

Many of the target users of the present invention have a deteriorating condition which might intensify the specific limitation of the user, thus, according to another embodiment of the present invention the method provided further comprises the steps of:
f. for a given user, saving the values of one or more pre-defined parameters out of the plurality of pre-defined parameters associated with that user's evaluation;
g. re-evaluating the user's one or more physical or cognitional limitations every at least pre-defined period of time and re-assigning values to the plurality of pre-defined parameters based on this re-evaluation; and
h. comparing the re-assigned values with the saved values of the plurality of pre-defined parameters, and determining whether any of the re-assigned values are substantially different from the saved values, and if in the affirmative, re-adjusting at least one of said PC settings' values, based on the value of the plurality of pre-defined parameters having re-assigned values different from the respective saved values.

In accordance with another aspect of the present invention a method is provided for adapting a searching engine interface to a user, the method comprising:
a. acquiring personal information associated with the user (e.g. age, gender, known disease(s), job, hobbies, fields of interest, geographical location, etc.);
b. in response to a query for information initiated by the user, retrieving a list of results that correspond to the query;
c. applying one or more prioritizing algorithms that are based on the acquired personal information for screening the retrieved results and to derive suitable results therefrom for displaying to the user;
d. connecting the user directly to a web site; and
e. displaying to said user information based on the suitable results.

Although the present invention should not be understood as being limited to a specific implementation of the method provided, an example of a search algorithm used in accordance with the present invention is demonstrated in FIG. 4.

According to a related embodiment of the invention the step of applying the one or more prioritizing algorithms comprises using information derived from the values of one or more of the plurality of pre-defined parameters associated with the user.

For example, if a certain user is color blind, the prioritizing algorithm uses this information for giving a higher ranking for web sites with distinguished color separation.

In accordance with yet another embodiment of the present invention, for each of the displayed results, the method preferably further comprises a step of enabling the user to directly link (i.e. to connect) to a web site associated with one or more respective results from among the displayed results. Optionally, the step of enabling the user to directly link to a web site comprises navigating the user automatically to the web site associated with one or more of the suitable results, thereby in response to his/her query the user receives the relevant web page of the site being a result found in the search conducted.

According to another embodiment of the present invention, the method provided further comprises a step of reverting to the computer's pre-defined default configuration (e.g. the default configuration of the display and/or the default configuration of the mouse, etc.) in response to pressing a pre-defined key at the PC keyboard.

According to another aspect of the present invention, there is provided a computer program product encoding a computer program stored on a non-transitory computer readable storage medium for executing a process comprising a set of instructions, by a personal computer (PC), wherein said process comprises: evaluating one or more physical or cognitional limitations of a user of the Personal Computer (PC), having one or more physical and/or cognitional limitations; assigning values to a plurality of pre-defined parameters based on the user's own evaluation, wherein at least one of the plurality of pre-defined parameters is a member of a group consisting of: brightness value, contrast value, background color, text size value, text color preference, time duration between two consecutive mouse clicks (double click), cursor size value, icons size value, Keyboard sensitivity value, mouse sensitivity value, and the like; and adjusting at least one of the settings' values of the PC used by the user, based on the value of the one or more pre-defined parameters selected out of the plurality of pre-defined parameters, to provide an improved PC experience for the user, by the adjustment of the PC settings to suit the user's limitations, the user may better enjoy and interact with the programs displayed onto his/her computer.

In accordance with another embodiment of this aspect of the present invention, the at least one of the settings' values of a PC to be adjusted, is a member of a group consisting of: screen brightness, screen contrast, screen background color, text size, text color, time period between double clicks on the mouse, cursor size, icons' size, Keyboard sensitivity, mouse sensitivity, age, gender, residence, known disease, job, hobbies, and the like.

In accordance with yet another embodiment of this aspect of the present invention, the step of adjusting at least one of the settings' values of the PC used by the user, is further based upon a specific limiting physiological and/or cognitional condition experienced by the user to enable adjusting display parameters of the PC to comply with the limitation.

According to still another embodiment of this aspect of the present invention, the process further comprises the steps of: associating the values of one or more pre-defined parameters, out of the plurality of pre-defined parameters, with a specific user from among that plurality of users and saving the associated values; and, upon identifying the specific user, adjusting at least one of the PC settings values, based on the saved values of the one or more pre-defined parameters that are associated with the identified specific user, to enable providing that user with an improved (tailored) PC experience.

By yet another embodiment of this aspect of the present invention, the process further comprises the following steps: for a given user, saving the values of one or more pre-defined parameters out of the plurality of pre-defined parameters associated with that user's evaluation; re-evaluating the user's one or more physical or cognitional limitations every pre-defined period of time and re-assigning values to the plurality of pre-defined parameters based on this re-evaluation; comparing the re-assigned values with the saved values of the plurality of pre-defined parameters, and determining whether any of the re-assigned values are substantially different from the saved values, and if in the affirmative, re-adjusting at least one of said PC settings' values, based on the value of the plurality of pre-defined parameters having re-assigned values different from the respective saved values.

According to yet another embodiment, the process further comprises the following steps: acquiring personal information associated with the user (e.g. age, gender, known disease(s), job, hobbies, fields of interest, geographical location, etc.); in response to a query for information initiated by the user, retrieving a list of results that correspond to the query; applying one or more prioritizing algorithms that are based on the acquired personal information for screening the retrieved results to derive suitable results for displaying to the user; and enabling display of information to the user based on the suitable results.

Preferably, the step of applying the one or more prioritizing algorithms comprises using information derived from the values of one or more of the plurality of pre-defined parameters associated with the user.

In accordance with yet another embodiment, for each of the displayed results, the process further comprises a step of enabling the user to directly link to a web site associated with one or more respective results from among the displayed results. Optionally, the step of enabling the user to link directly to one or more web sites comprises navigating the user automatically to the web site associated with one or more of the suitable results, thereby in response to his/her query the user receives the home page of the site being a result found in the search conducted.

According to another embodiment of the present invention, the process further comprises a step of reverting to the computer's pre-defined default set-up in response to pressing a pre-defined key at the PC keyboard.

### BRIEF DESCRIPTION OF THE DRAWINGS

A better understanding of the present invention may be obtained when the following non-limiting detailed description is considered in conjunction with the accompanying figures.

FIG. 1—is a flow chart that describes the implementation of the adapted search method;

FIG. 2—is a screen shoot of Google retrieved list results inserting a search query for the word “diapers”;

FIG. 3—is a screen shoot of an interactive search conducted according to the method provided by the present invention;

FIG. 4—demonstrates an example of a search algorithm, according to the present invention; and

FIG. 5—is a screen shoot of the Mr. Anderson result when he queried the word “diapers” according to a search carried out in accordance with the present invention.

### DETAILED DESCRIPTION OF THE PRESENT INVENTION

The current invention provides a method and a computer program product that improves computer and Internet accessibility for people having certain limitations. As discussed above, there are several physical limitations and physiological barriers that are likely to spoil the computer and internet experience for many users. According to one embodiment of the present invention some of the physical limitations and the physiological barriers are reduced by providing the user with simple pre-set selection of display modes that target common limitations characterizing the target population.

Table 1 provides examples of six display modes. Each of the display modes is associated with some vision-related limitations, and characterized by having different values for the visual parameters.

TABLE 1

| | Display mode | | | | | |
|---|---|---|---|---|---|---|
| | Mode 1 | Mode 2 | Mode 3 | Mode 4 | Mode 5 | Mode 6 |
| Limitation: | None | Acuity | Contrast | Glare | Color | Narrow- |
| | | | discrimination | sensitivity | perception | angle |
| | | | | | | vision |
| Brightness | Normal | Normal | High | Low | Normal | Normal |
| value: | | | | | | |
| Contrast | Normal | Medium- | High | High | Normal | Normal |
| value | | high | | | | |
| Background | White | White | White | Beige | White | White |
| color | | | | | | |
| Text size | Normal | Medium- | Medium-large | Normal | Normal | Small- |
| value | | large | | | | medium |
| Text color | Default | Default | Dark | Dark | No blue or | Default |
| | | | | | green | |

One way for setting the visual parameters that characterize each display mode is by presenting the limited internet user with examples of a typical web page modified according to each of these display modes for him to select the mode that is most convenient for him. However, it should be clear to any person skilled in the art that other ways may be used for setting the visual parameters, and they are all encompassed by the scope of the present invention.

In addition to the display mode which is designed to solve vision-related limitations, further parameters may be modified in order to provide a response to needs arising out of other physical limitation. Table 2 provides examples of five interface modes, where each interface mode is associated with a physical limitation, and characterized with different values of interface parameters.

TABLE 2

| | Interface mode | | | | |
|---|---|---|---|---|---|
| | Mode 1 | Mode 2 | Mode 3 | Mode 4 | Mode 5 |
| Physical | None | Low eye- | Low hand | Slowness | Shaking |
| Limitation: | | hand | and fingers | | |
| | | coordination | dexterity | | |
| Time gap | Normal | Normal | Big | Big | Low |
| between | | | | | |
| double clicks | | | | | |
| Size of | Normal | Big | Normal | Normal | Big |
| cursor and | | | | | |
| icons | | | | | |
| Keyboard | Normal | Normal | High | Normal | Low |
| sensitivity | | | | | |
| Dragging | Normal | High | High | Normal | Low |
| mouse | | | | | |
| sensitivity | | | | | |

According to one embodiment of the invention, one way for setting the interface parameters that characterize each of the interface modes is done by presenting to the limited internet user a questionnaire wherein he/she is asked to exercise few relatively simple tasks, and based upon his/her performance, to assign values to the interface parameters thereby enabling the selection of the best fitting interface mode for that user.

In accordance with other examples of carrying out the present invention, the limitations of people suffering from certain cognitive conditions are taken into account while assigning values to the interface parameters in order to enable a selection of the best fitting interface mode for such users. Examples for such limitations are people with MCI (Mild cognitive impairment) who may suffer from too much information load, people with ADD, loss of concentration and high level of sensory integration who may suffer from distraction caused by moving graphics (banners, flash, tickers, etc.), and the like.

Other ways for determining these interface parameters for the different (types of) users should also be understood to be encompassed by the present invention.

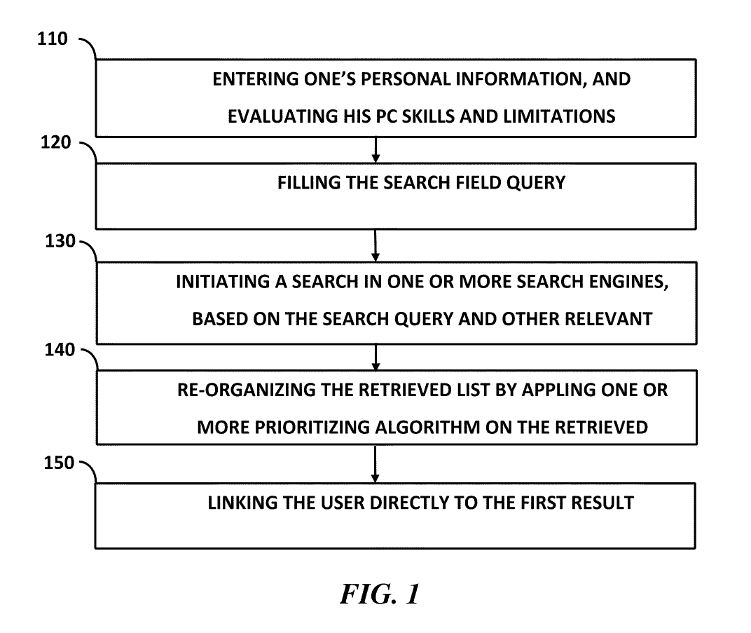

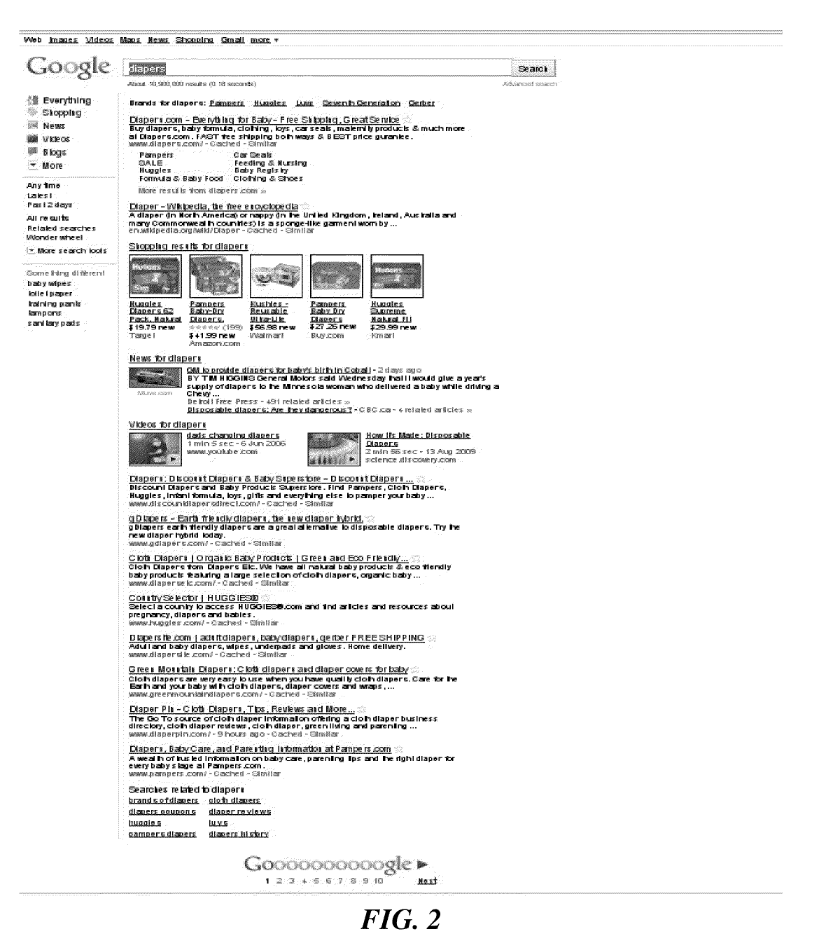

As aforesaid, one of the objects of the present invention is to provide a tailored PC experience for the PC user. Another object of the present invention relates to search for information using the Internet. Currently, most search engines are operative to provide in response to a query inserted by a user, a list of results pre-prioritized based on the search provider's own algorithm. Although some of the search engines offer the user a customized option which is based upon his browsing history, this option is hardly suitable for elderly people. Instead of using a “what you type is what you get” type of search engine, the present invention offers a method that is oriented for elderly and people having certain limitations as discussed above, which is more targeted to the person making the query, sort of “what you're looking for is what you get” search engine. FIG. 1 is a flow chart that describes an example of implementing the present invention. Let us take in this example Mr. Anderson, who is a 70 years old male from Boston and is color blind. In the initial step (110) Mr. Anderson enters his personal information, and his PC skills and limitations are being evaluated as described above. Next, Mr. Anderson enters to the search field certain key words that he is interested in (120). In this example Mr. Anderson typed the word “diapers”. FIG. 2 provides a list of results obtained when the Google® search engine was used. These results are what Mr. Anderson would have received, had he used such a commonly used search engine. As may be seen rather clearly, only the tenth result is somewhat relevant for Mr. Anderson. However, continuing with the example of the method carried out in accordance with the present invention, a search is initiated in one or more internet search engines (such as Google, Bing or other Internet search engines, while taking into consideration Mr. Anderson's condition) using Mr. Anderson's query and other personal information that might be relevant (130). Next, one or more prioritizing algorithm are applied onto the retrieved results (140), where the prioritizing algorithms are adapted to modify the position in the list of the results found, in order to give more weight to Mr. Anderson's personal information and/or to the fact that Mr. Anderson is color blind, subject to the selected search domain. Upon re-organizing the retrieved results, preferably, instead of providing the user with a list of results which are more relevant to that user, the present invention offers a solution of directly linking Mr. Anderson to the first result, and enables him to browse between the retrieved results (150). Alternatively, Mr. Anderson may receive the relevant web page associated with the first result directly (without having to manually link to that web page) and may then move simply from one web page to another (instead of having to scroll down the list and going back and forth from the web pages to the list) and review the entries contained thereat.

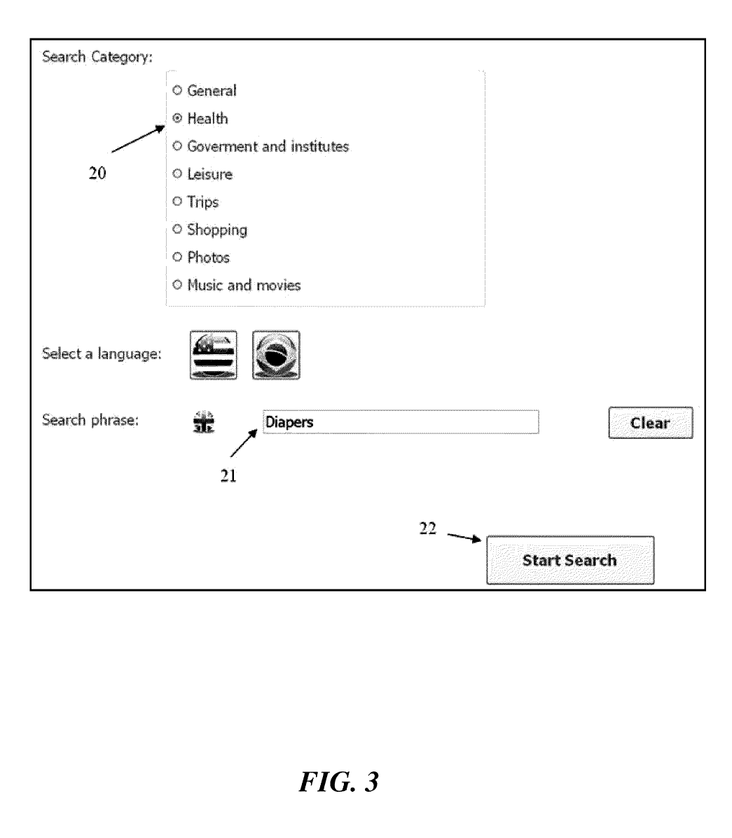

FIG. 3 provides an example of a search definition screen, according to an embodiment of the present invention. As can seen in this FIG., besides the common text box designed for entering the search phrase (21), the search definition screen provides means to enable selecting a search category from among several search categories displayed (20) (e.g. health, leisure, government and institutes etc.), so that the PC user may choose a category in order to improve the search results.

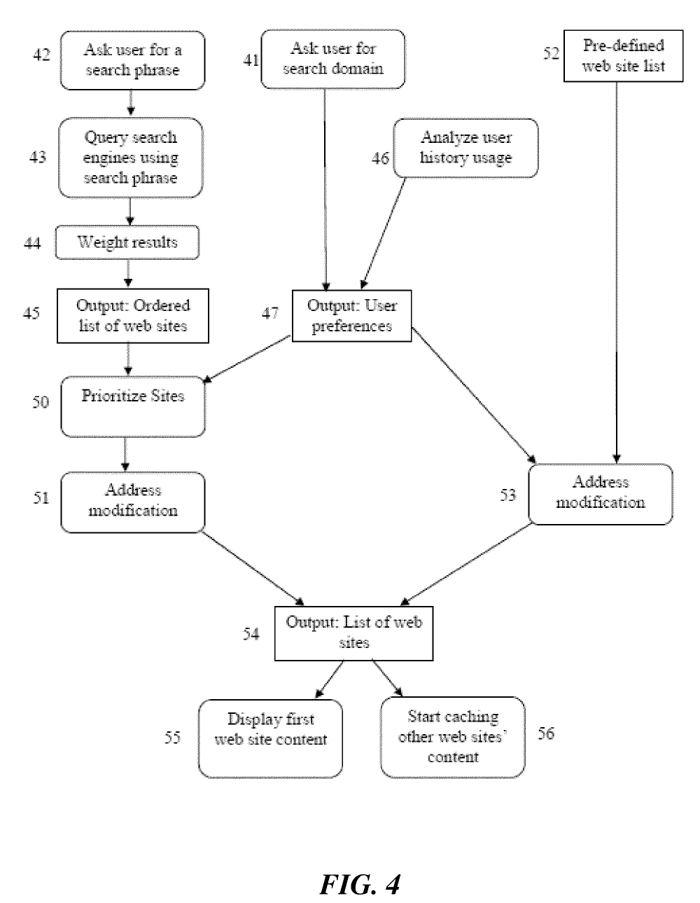

FIG. 4 presents a block diagram of a search algorithm implementing certain embodiments of the present invention. AS will be appreciated, this algorithm should not be considered to limit in any way the present invention. The algorithm starts when the PC user has provided the search domain (41) and the search phrase (42). First, one or more search engines are queried using the search phrase (43). If more than one search engine is used, the results are combined by a weighting algorithm (44). According to the present embodiment, the weight algorithm assigns higher weight to results which are located at the first search results, and to recurring results. The weight algorithm results in an ordered list of web sites (45).

According to the embodiment described in this current example, a background process (46) continuously records user usage patterns e.g. common search domains, search phrases, search words, sites saved in the ‘favorites’ list, visited sites and the time and page-depth spent in each site etc. The result of the historical results (46) and the search domain the user has provided (41), are regarded as an indication of the user's own preferences (47).

Another algorithm (50) is used to prioritize the search result sites, while taking into consideration the ordered list from the search engines (45) and user preferences (47). If needed, site addresses in the resulting prioritized list (50) are modified (51) to better reflect the search query.

A similar process of address modification (53) is carried out on a pre-defined list of web sites (52) that includes (preferably for every search domain) a list of sites that best suit the most common needs of users with similar conditions as the current PC user.

The two lists—one resulting from the search engines (51) and the other from the pre-defined web site list (53)—are combined, again using a weighting algorithm to generate the final result list (54). The first web page in the list is loaded and presented to the user (55) while a background process (56) downloads the following web pages and caches them at the computer memory. Thus, when the user navigates to the next results, they may be displayed faster for him.

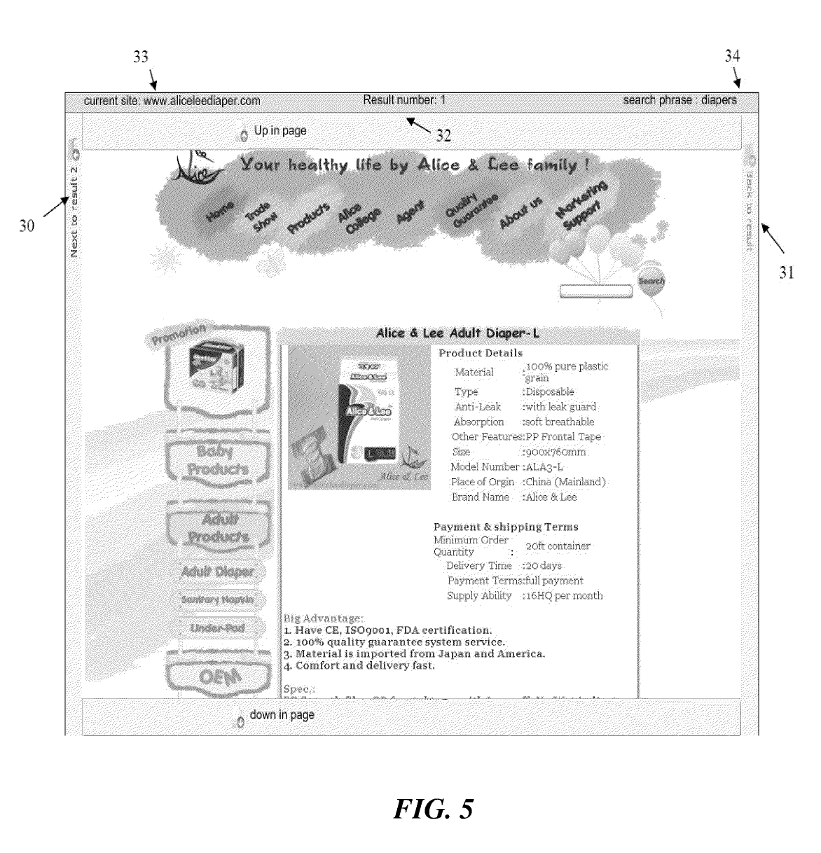

FIG. 5 provides the result of Mr. Anderson's search (the 70 years old male from Boston) after the list has been finalized and prioritized according to the present invention and the browser navigates to the web site of the first result. Mr. Anderson has a reminding indication of the result he watches—its number (32), its address (33) and the original search query (34). He also has graphical controls to continue to the next search result (30) should he desire to do so, or to go back to the previous search result (31). In any case, he does not have to be bothered with the resulting list itself, and does not have to be familiar with search engines and ways of mastering their results.

It is appreciated that various features of the invention that are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described herein above. Rather the scope of the invention is defined by the claims that follow.

1. A method for providing a user of a Personal Computer (PC) having one or more physical and/or cognitional limitations, with an improved PC experience, wherein said method comprising:
a. evaluating one or more physical or cognitional limitations of the user;
b. assigning values to a plurality of pre-defined parameters associated with the user, wherein at least one of the plurality of pre-defined parameters is a member of a group consisting of: brightness value, contrast value, background color, text size value, text color preference, time duration between two consecutive mouse clicks (double click), cursor size value, icons size value, Keyboard sensitivity value and mouse sensitivity value; and
c. adjusting at least one of the settings' values associated with the PC used by the user, based on the value of the one or more pre-defined parameters selected out of the plurality of pre-defined parameters, to enable providing a tailored PC experience to the user.

2. The method according to claim 1, wherein at least one of the settings' values of a PC to be adjusted is a member of a group consisting of: screen brightness, screen contrast, screen background color, text size, text color, time period between double clicks on the mouse, cursor size, icons' size, Keyboard sensitivity and mouse sensitivity.

3. The method according to claim 1, wherein the step of adjusting at least one of the setting' values of the PC used by the user, is further based upon a specific limiting physiological and/or cognitional condition to enable adjusting display parameters of the PC to comply with the limitation.

4. The method according to claim 1, wherein said method is adapted for use by a plurality of users using the same PC, each of which having one or more physical and/or cognitional limitations and wherein the method further comprising the steps of:
d. associating the values of one or more pre-defined parameters, out of said plurality of pre-defined parameters, with a specific user from among said plurality of users and saving the associated values; and
e. upon identifying said specific user, adjusting at least one of the PC settings values, based on the saved values of the one or more pre-defined parameters that are associated with the identified specific user, to enable providing said user with a tailored PC experience.

5. The method according to claim 1, wherein said method further comprises the steps of:
f. for a given user, saving the values of one or more pre-defined parameters out of the plurality of pre-defined parameters associated with said user's evaluation;
g. re-evaluating the user's one or more physical or cognitional limitations every at least pre-defined period of time and re-assigning values to the plurality of pre-defined parameters based on said re-evaluation; and
h. comparing the re-assigned values with the saved values of the plurality of pre-defined parameters, and determining whether any of the re-assigned values are substantially different from the saved values, and if in the affirmative, re-adjusting at least one of said PC settings' values, based on the value of the plurality of pre-defined parameters having re-assigned values different from the respective saved values.

6. The method according to claim 1, wherein the step of assigning values to a plurality of pre-defined parameters based on the user own evaluation is based on presenting said user with examples of a typical display of text and/or graphics modified according to each of a plurality of display modes to enable said user to select a display mode that would be most convenient for him.

7. A method for adapting a searching engine interface to a user, said method comprising:
a. acquiring personal information associated with said user;
b. in response to a query for information initiated by the user, retrieving a list of results that correspond to said query;
c. applying one or more prioritizing algorithms that are based on the acquired personal information for screening the retrieved results and to derive suitable results therefrom for displaying to the user; and
d. connecting the user directly to a web site; and
e. displaying to said user information based on the suitable results.

8. A computer program product encoding a computer program stored on a non-transitory computer readable storage medium for executing a process comprising a set of instructions, by a personal computer (PC), wherein said process comprises: evaluating one or more physical or cognitional limitations of a user of the Personal Computer (PC), having one or more physical and/or cognitional limitations; assigning values to a plurality of pre-defined parameters based on the user's own evaluation, wherein at least one of the plurality of pre-defined parameters is a member of a group consisting of: brightness value, contrast value, background color, text size value, text color preference, time duration between two consecutive mouse clicks, cursor size value, icons size value, Keyboard sensitivity value and mouse sensitivity value; and adjusting at least one of the settings' values of the PC used by the user, based on the value of the one or more pre-defined parameters selected out of the plurality of pre-defined parameters, to provide an improved PC experience for the user.

9. The computer program product of claim 8, wherein said at least one of the settings' values of a PC to be adjusted, is a member of a group consisting of: screen brightness, screen contrast, screen background color, text size, text color, time period between double clicks on the mouse, cursor size, icons' size, Keyboard sensitivity, mouse sensitivity, age, gender, residence, known disease, job and hobbies.

10. The computer program product of claim 8, wherein the step of adjusting at least one of the settings' values of the PC used by the user, is further based upon a specific limiting physiological and/or cognitional limitation experienced by the user to enable adjusting display parameters of the PC to comply with said limitation.

11. The computer program product of claim 8, wherein the process further comprises the steps of: associating the values of one or more pre-defined parameters, out of the plurality of pre-defined parameters, with a specific user from among that plurality of users and saving the associated values; and, upon identifying the specific user, adjusting at least one of the PC settings values, based on the saved values of the one or more pre-defined parameters that are associated with the identified specific user, to enable providing that user with an improved (tailored) PC experience.

12. The computer program product of claim 8, wherein the process further comprises the following steps: for a given user, saving the values of one or more pre-defined parameters out of the plurality of pre-defined parameters associated with that user's evaluation; re-evaluating the user's one or more physical or cognitional limitations every pre-defined period of time and re-assigning values to the plurality of pre-defined parameters based on this re-evaluation; comparing the re-assigned values with the saved values of the plurality of pre-defined parameters, and determining whether any of the re-assigned values are substantially different from the saved values, and if in the affirmative, re-adjusting at least one of said PC settings' values, based on the value of the plurality of pre-defined parameters having re-assigned values different from the respective saved values.

13. The computer program product of claim 8, wherein said process further comprises the following steps: acquiring personal information associated with the user; in response to a query for information initiated by said user, retrieving a list of results that correspond to the query; applying one or more prioritizing algorithms that are based on the acquired personal information for screening the retrieved results to derive suitable results for displaying to the user; and enabling display of information to said user based on the suitable results.

14. The computer program product of claim 13, wherein the process further comprises a step of enabling the user to link directly to one or more web sites for retrieving the information to be displayed to said user.
